(19) United States
(12) Patent Application Publication
(10) Pub. No.: US 2024/0138420 A1
(43) Pub. Date: May 2, 2024

(54) A COMPOSITION AND PROCESS FOR IMPROVING A PLANT'S ABILITY TO REDUCE ATMOSPHERIC CO2

(71) Applicant: Aussan Laboratories Pty Ltd, Campbellfield, Victoria (AU)

(72) Inventor: Kevin John JOYCE, Chatswood (AU)

(73) Assignee: Aussan Laboratories Pty Ltd, Campbellfield, Victoria (AU)

(21) Appl. No.: 18/280,170

(22) PCT Filed: Mar. 3, 2022
(86) PCT No.: PCT/AU2022/050176

§ 371 Date: Sep. 1, 2023

(30) Foreign Application Priority Data
Mar. 3, 2021 (AU) 2021900580

(51) Int. Cl. A01N 65/36; A01N 37/02; A01N 37/40; A01P 21/00

(52) U.S. Cl. CPC A01N 65/36; A01N 37/02; A01N 37/40; A01P 21/00

(57) ABSTRACT

A composition for increasing a plant's natural processes for absorbing CO2 from the atmosphere comprising: at least one bioflavonoid; and at least one organic acid.

### FIELD OF THE INVENTION

The present invention relates generally to a composition and process for reducing the impact of global warming, and in particular, to a composition and process for increasing a plant's natural processes for absorbing CO₂ from the atmosphere.

### BACKGROUND

Numerous scientific reports have identified global warming and climate change as the single greatest threat to the existence of mankind on this planet. Not only has global warming been shown to have a significant effect on weather patterns and rising sea levels, but there are a number of flow on effects, such as droughts, fires, increased pollution as well as higher temperatures in general, which pose a risk to human health.

The cause of global warming has largely been attributed to an increase in greenhouse gas emissions, largely caused by industrialisation and human contribution. Therefore, a significant focus on providing solutions for Global Warming is to identify ways in which the amount of gases in the atmosphere associated with the Greenhouse effect can be reduced. Carbon Dioxide has been identified as one of the more significant gases contributing to the greenhouse effect and thus, the greatest target. However, methods of reducing emissions of CO₂ are difficult to implement as they have a significant economic impact and it is commonly believed that it will take an exceedingly long time for such methods to have any significant effect.

Carbon Sequestration, in the form of long-term storage of Soil Organic Carbon (SOC), is a viable means to remove CO₂ from the atmosphere and store it in the ground over long periods. Agricultural soils around the world have been virtually depleted of carbon and SOC is vital in promoting crop health and in particular crop resilience through climate extremes such as drought. Improving SOC long term storage is not only a means to resolve CO₂ levels in the atmosphere but also to improve soil health and thereby crop nutrition and yields. Long term storage of SOC is reliant on soil biology, with mycorrhizal fungi in particular, playing a major role in the long-term sequestration of carbon.

There are other greenhouse gases that also pose a concern in relation to global warming. One particular gas of concern is Nitrous Oxide which, whilst only comprising a relatively small percentage of greenhouse gas emissions, has a particularly potent effect. Among the major sources of Nitrous Oxide is its release from agricultural soils and evidence indicates that this is primarily caused by over use of synthetic fertiliser inputs in agriculture, which are high in Nitrogen. In nature, Nitrous Oxide is converted by sunlight and oxygen into Nitrogen oxides. Nitrogen oxides are well known to deplete the protective Ozone layer and are considered to have around 300 times the warming power of CO₂ and stay in the atmosphere about 114 years on average.

It is well established that Plants (including trees) play an important role in absorbing gases from the atmosphere during photosynthesis. As part of this process plants absorb CO₂ from the air to form Glucose by combining the carbon and oxygen from CO₂ with a Hydrogen molecule from water. Towards the end of every day during the growth cycles of the plants, they transfer glucose down to the roots. Up to 60% of the glucose is then exuded from the roots, in a process called root exudation, which feeds and signals the soil organisms in the rhizosphere (root zone). As such, soil organisms and plant roots build a symbiotic relationship. Plants feed the organisms in the soil and the organisms provide benefits, such as nutrients, to the plants. The life cycle of the billions of life forms in the soil contributes to the carbon and it is logical that the higher soil biology population, the higher the amount of carbon that is held in the soil at a given time. Further to this, an increase of soil biology has been shown to reduce the need for synthetic fertilisers when used in cooperation with natural nutrient forms such as composts and other organic matter additives. By reducing the need for synthetic fertilisers that are high in Nitrogen, the release of Nitrous Oxide into the atmosphere through such fertiliser use is also minimised.

Thus, there is a need to provide a means by which a plant's natural processes can be enhanced to increase the absorption of CO₂ from the atmosphere to be transported back into the soil for capture and to improve soil health.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

According to a first aspect of the present invention there is provided a composition for applying to leaves or soil to facilitate enhanced plant CO₂ absorption and root exudation wherein the composition comprises at least one bioflavonoid and at least one organic acid.

Preferably, the composition includes at least one wetting agent. More preferably, the at least one wetting agent is naturally plant derived.

Preferably the composition includes one or more of Boron, magnesium and Calcium at micron size particles capable of plant absorption.

The at least one bioflavonoid may be naturally plant derived. Further, the organic acid may be a naturally produced organic acid.

Preferably, the composition is in the form of a liquid. The composition may comprise a topical composition which is diluted at a rate of 0.25 to 20 ml per litre of water or another diluting agent. More preferably, the composition is suitable for application to plant foliar. Alternatively, the topical composition is suitable for application as an irrigation additive. The irrigation addictive could be delivered by a drip system or other irrigation method.

In a most preferred embodiment, the composition comprises:
between 10% to 20% (by weight) at least one bioflavonoid; or
between 30% to 60% (by weight) at least one organic acid; and/or
between 10% to 20% (by weight) at least one wetting agent and
between 0.5% to 5% (by weight) of micronutrients of one or more boron, magnesium and calcium

The at least one bioflavonoid may be selected from any plant extracted flavonoid which is naturally plant derived. The at least one bioflavonoid may be selected from the group including: citrus fruit plant extracts, including grapefruit, lemon, lime, orange, tangerine, bitter orange extract.

The at least one organic acid may be selected from a group of mild organic acids that include: malic acid, citric acid, lactic acid, salicylic acid, caprylic acid and tartaric acid.

The at least one wetting agent may be selected from a natural plant derived surfactant.

The composition may include plant foliar or irrigation treatments including at least one of plant growth regulators and micro nutrients.

In accordance with another aspect of the invention, there is provided a method of simultaneously increasing a plant's natural processes for absorbing CO₂ from the atmosphere and for releasing carbohydrates into the soil comprising: forming a liquid composition comprising at least one bioflavonoid and at least one organic acid; diluting the liquid composition by adding a diluting agent at a rate of between 0.25 ml to 20 ml liquid composition per litre of diluting agent; spraying a first application of the diluted liquid composition to the leaves of a plant early in the growing season of the plant; and spraying a second application of the diluted liquid composition to the leaves of a plant at least 3-7 days after the first application.

In one embodiment, the liquid composition further includes one or more of Boron, Magnesium and Calcium at micron size particles capable of plant absorption.

In a preferred embodiment, the at least one diluting agent may be water.

The at least one organic acid may be selected from a group of mild organic acids that include: malic acid, citric acid, lactic acid, salicylic acid, caprylic acid and tartaric acid.

In a preferred embodiment, the diluting agent may be added at a rate of between 0.4 ml to 4 ml liquid composition per litre of diluting agent.

The first application and the second application may be sprayed on the leaves of the plant in a light mist or fine spray to cover the leaves.

### BRIEF DESCRIPTION OF THE DRAWINGS

The invention may be better understood from the following non-limiting description of preferred embodiments, in which:

FIG. 1 is a bar graph showing results of a trial conducted by the Applicant depicting percentage difference in ripe bunches of grapes;

FIG. 2 is a graph depicting change in soil health associated with almond trees treated with the composition of the present invention in accordance with a trial conducted by the Applicant;

FIG. 3 is a graph depicting measured soil microbial health in pear trees treated with the composition of the present invention in accordance with a trial conducted by the Applicant;

FIG. 4 is a graph depicting measured soil microbial health in cherry trees treated with the composition of the present invention in accordance with a trial conducted by the Applicant;

FIG. 5 is a bar graph showing Leaf BRIX as a measure of glucose production in a grape vines treated with the composition of the present invention in accordance with a trial conducted by the Applicant;

FIG. 6 is a bar graph showing dry weight of tomato shoots and tomato roots treated with the composition of the present invention in accordance with a trial conducted by the Applicant;

FIG. 7 is a graph depicting internal CO₂ (mmol m−3) measurements taken from tomato plants in accordance with a trial of the composition of the present invention conducted by the Applicant;

FIG. 8 is a graph depicting internal CO₂ (mmol m−3) measurements taken from tomato plants in accordance with a trial of the composition of the present invention conducted by the Applicant;

FIG. 9 is a graph depicting CO₂ assimilation (pmol m−2 s−1) measurements taken from tomato plants in accordance with a trial of the composition of the present invention conducted by the Applicant; and

FIG. 10 is a graph depicting percentage increase of nutrients in tomato plants in accordance with a trial of the composition of the present invention conducted by the Applicant

### DETAILED DESCRIPTION OF THE INVENTION

The present invention will be described below in relation to a composition and process for applying the composition to plants so as to cause the plants to simultaneously substantially increase the amount of CO₂ they absorb from the atmosphere and the carbohydrates they release into the soil. The effects of increased CO₂ absorption in plants increases the amount of glucose the plant can produce through photosynthesis which results in more carbon being released into the soil via the roots of the plant in a process called root exudation. This has the effect of improving soil health which has a flow-on effect of increasing plant health and ultimately the production of more and better fruit or grain and faster growth of plants and trees. It will also be appreciated that by promoting an increase in carbon rich root exudates into the soil the need for synthetic nitrogen fertilisers reduces. It is noted that synthetic fertilisers contribute to the release of Nitric Oxide from the soil which is converted by sunlight to Nitrous Oxides to become a harmful and highly potent greenhouse gas.

Flavonoids have been shown to stimulate a range of functions in plants and trees. In accordance with an embodiment of the present invention, the invention seeks to provide two main functions simultaneously that work in concert to create a perpetual cycle that removes CO₂ from the air and builds soil biological health within the rhizosphere of plants and trees. The functions of the present invention that are improved are Photosynthesis and Root Exudation. Photosynthesis takes CO₂ from the air with water and sunlight to create glucose. This glucose forms a variety of carbohydrates used by the plant to grow. However, in the process of root exudation a large portion of these carbohydrates are released into the soil to feed and stimulate soil biology. Among these is the stimulation of mycorrhizal spore germination and hyphal branching which increase soil carbon content and capture. In this regard, the present invention is directed towards manipulation of the flavonoid pathway to improve soil health by increased soil biology and the plant root interaction with the said biology.

Preferred embodiments of the present invention are directed to compositions for the general improvement and increasing glucose production and transportation in plants and/or increasing beneficial soil microbial populations. The compositions preferably comprise at least one bioflavonoid in combination with at least one organic acid. The compositions may also include at least one wetting agent. Specifically, it has been proven that simultaneously photosynthesis efficiency and root exudation is improved by use of these compositions, in accordance with the present invention.

In a preferred form, the composition of the present invention is applied to the foliar of the plant and provides the advantage of stimulating production of plant compounds, named polyphenols, which are needed for many functions in plants including the process of secondary metabolism where the plants are not able to adequately produce these compounds due to the effects of abiotic or biotic stress condition. In addition, it is understood that the treatment of plants with the composition of the present invention improves plant processes centred around flavonoid production in the roots. The follow-on effect of this is an improvement in the plants relationship with soil microbiology resulting in a rise in the population of microbes around the roots of the plant.

In a preferred embodiment of the invention, the composition comprises at least one bioflavonoid and at least one organic acid. Preferably the composition includes at least one wetting agent. In particular, it is preferred that the at least one bioflavonoid, the at least one organic acid and/or the at least one wetting agent are naturally plant derived ingredients or naturally produced elements.

In a preferred embodiment of the invention the composition may include micronutrients and plant growth regulators to assist the plant health and energy production.

Preferably, the composition is present in the topical composition at between 0.25 ml to 20 ml per litre of diluting agent such as water, more preferably, between 0.4 to 4 ml per L of diluting agent. However, the dilution can vary, as would be understood by a person skilled in the art, depending on different factors such as soil condition, foliage cover, growth rate, crop type, weather, water used per hectare etc. The topical composition can be applied as a plant foliar spray on the roots, stems or leaves, or as an irrigation additive delivered via a drip system.

The composition improves the relationship with the soil microbes and the plant to provide an ongoing benefit to the plant's health. The cycle of healthy soil and healthy plant can be maintained by additional applications through the growing season but single applications have shown an ongoing effect. Preferably, the product is applied to plants during the cool of the day, and preferably not prior to, or just subsequent to, rain. As the product is taken up by the leaves of the plant, it is better, should it be likely to rain within six hours of application, to apply the product at a later time.

Most preferably, for best results, the product can be sprayed in a light mist or fine spray that covers the leaves. The first spray application is typically early in the growing season of the plant, when new leaves form, and the spray be repeated some three-seven days, preferably five days, after the first spray.

The composition advantageously provides a way to regenerate poor soils and invigorate soils under stress conditions. The natural process of soil health regeneration can take years as each season provides a short window of opportunity. With the embodiments of the present invention the time to regenerate a healthy soil is considerable shortened. Ongoing soil health is also maintained throughout a season and onto the next. Healthy soils and crops can sequester far more carbon into the soil which can contribute to reduced CO₂ gases in the atmosphere. Healthy soils and crops provide higher nutritional value and flavour to food.

In a particular embodiment, the composition comprises:
between 10% to 20% (by weight) at least one bioflavonoid; or
between 30% to 60% (by weight) at least one organic acid; and/or
between 10% to 20% (by weight) at least one wetting agent and
between 0.5% to 5% (by weight) of micronutrients boron and calcium

As the composition comprises entirely of naturally plant derived ingredients there is no toxicity at recommended topical application dilution levels. The naturally derived components of the compositions may be found on lists, such as the USDA GRAS list which is generally recognised as safe levels for food or dietary supplements. Specifically, the safe levels as recommended by the USDA GRAS list are much higher doses than the levels of the composition in a topical application dilution level. Thus, the compositions are much more acceptable to consumers who prefer and demand less harmful agricultural additives to those currently used in traditional agricultural methods.

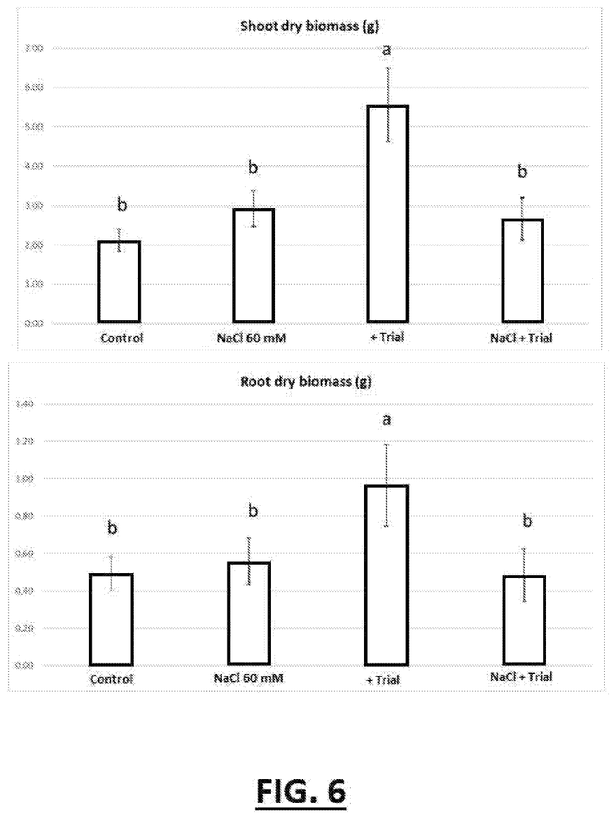

As part of the development process, the applicant has determined that when plants or soil have been treated with the composition of the present invention, the composition effects noticeable improvement of plant biomass development, both above and below the ground. This is clearly shown in the graph of FIG. 6, which was collected from a trial conducted by the Applicant on tomato plants.

In this trial, seeds of tomato (Solanum lycopersicum cvMarmande from Ramiro Arnedo, Spain) were pre-hydrated with de-ionised water and aerated continuously for 24 h. After this, the seeds were germinated in vermiculite, in the dark at 28° C., for three days. Then, the seedlings were transferred to a controlled-environment chamber with a light-dark cycle of 16 h-8 h, a temperature of 25° C.-20° C. and relative humidities of 60%-80%. Photosynthetically-active radiation (PAR) of 400 μmol m−2 s−1 was provided by LEDs. The Seedlings were then transferred to hydroponic conditions in 16-L containers (6 plants in each) filled with Hoagland's solution, pH 5.5. The solution was continuously aerated and was changed every week. The composition of the solution was: 6 KNO3, 4 Ca(NO3)2, 1 KH2PO4, and 1 MgSO4 (mM), and 25 H3BO3, 2 MnSO4, 2 ZnSO4, 0.5 CuSO4, 0.5 (NH4)6Mo7O24, and 20 Fe-EDDHA (μM). To half of the containers 60 Mm NaCl was applied after 5 days of growing. After 10 days, a first foliar spray of the composition of the present invention was applied (diluted to 3 ml L−1) to half of the control treated plants and to half of the NaCl treated plants. Applications of 25 ml per plant were performed. After 5 days other application of the composition of the present invention was performed. The measurements and samples collection was carried out after 3 days from the second foliar treatment. Growth determined by weight, gas exchange parameters, leaf water relations and relative water content was also determined. After these two-week treatments, four plants from each sample were weighed to obtain the fresh weight, separating the root from the aerial part, and then left in an oven (60° C.) for five days until they were completely dry, weighing them again to obtain the dry weight (DW).

As can be clearly seen from the graphs of FIG. 6, biomass improvement in the plants treated with the composition of the present invention was clearly shown. Further effects have been recorded in accelerated maturity allowing earlier harvest of produce. This is especially important for food crops and other important plant types, such as forestry trees.

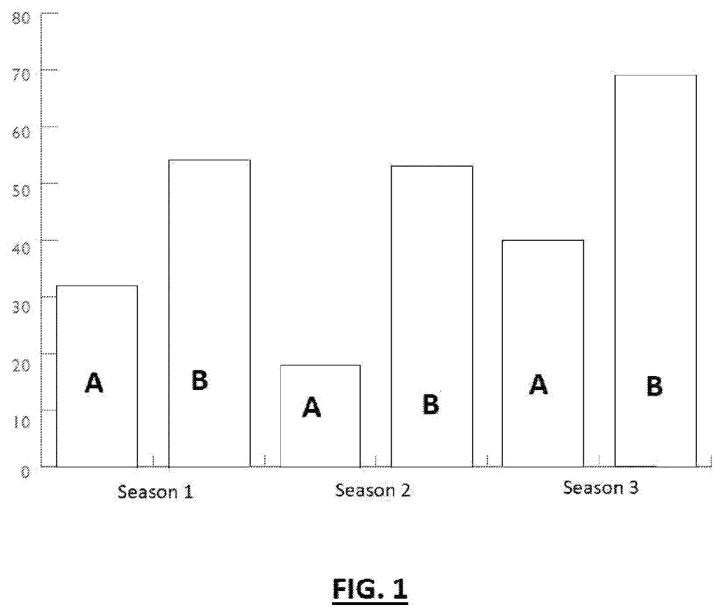

In this regard, FIG. 1 depicts results of a study undertaken by the Applicant in determining the percentage difference in ripe bunches of Pinot Noir grapes in a New Zealand based vineyard across three separate seasons. The graphs depicted as ‘A’ are representative of vines that have not been treated with the composition of the present invention and the graphs depicted as ‘B’ are representative of vines that have been treated with the composition of the present invention. As can be clearly seen, those vines treated with the composition of the present invention have a greater percentage difference in ripe bunches of grapes confirming that by treating the vines with the composition of the present invention, early ripening of the grapes is achieved.

In a preferred embodiment, the composition is in a liquid form. The composition can be easily produced into a topical composition by being diluted with a diluting agent, such as water. In a particularly preferred embodiment, the composition is present at between 0.4 to 4 ml when diluted in 1 L of water or other diluting agent.

As previously discussed, the effects of flavonoids in root exudates stimulate soil biology. Trials conducted by the applicant conclude increased soil biology populations in the rhizosphere of up to 300% of treated plants when compared to untreated plants. The results of one such trial are depicted below, in Table 1. In this trial, the composition of the present invention was applied to four grape varieties in a vineyard, with the results compared to a control that was untreated with the composition of the present invention. The data shown is obtained from a laboratory analysis of soil fungi present in the samples. Mycorrhizal fungi releases a sticky carbon-based substance called glomalin, which is responsible for 30% of all the humus (organic carbon) in the soil. Fungi are important to a plant's available nutrition and the results clearly show that the Trial product generates a significant percentage change in soil fungi development in the plants.

TABLE 1
Active Fungi (ug/g)

| Variety | Control | Trial | % Change |
|---|---|---|---|
| Shiraz | 117 | 279 | 138% |
| Shiraz | 2.78 | 6.3 | 127% |
| Shiraz | 2.07 | 12.5 | 504% |
| Pinot | 0.95 | 6.86 | 622% |

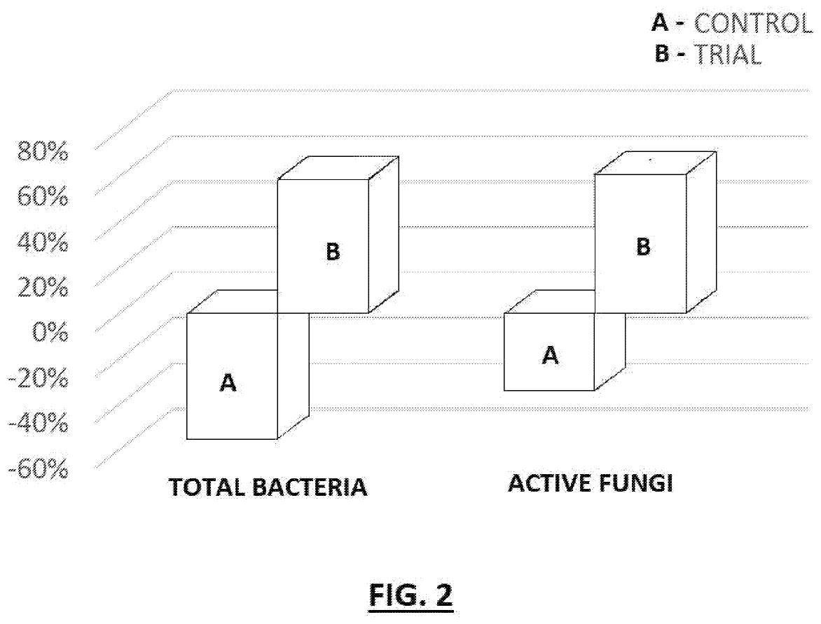

FIG. 2 depicts the results of another study undertaken by the Applicant to determine the effect of the composition of the present invention on soil health. This test was conducted on almond trees with the control ‘A’ referring to those trees in the trial that were not sprayed with the composition of the present invention and the trial ‘B’ referring to the trees that were sprayed with the composition of the present invention in accordance with the described method of application. As can be clearly seen in FIG. 2, the change in the measurement of the total bacteria present in the soil and the active fungi present in the soil from baseline to the end of season, clearly shows that the composition of the present invention significantly increases the soil health of the trees.

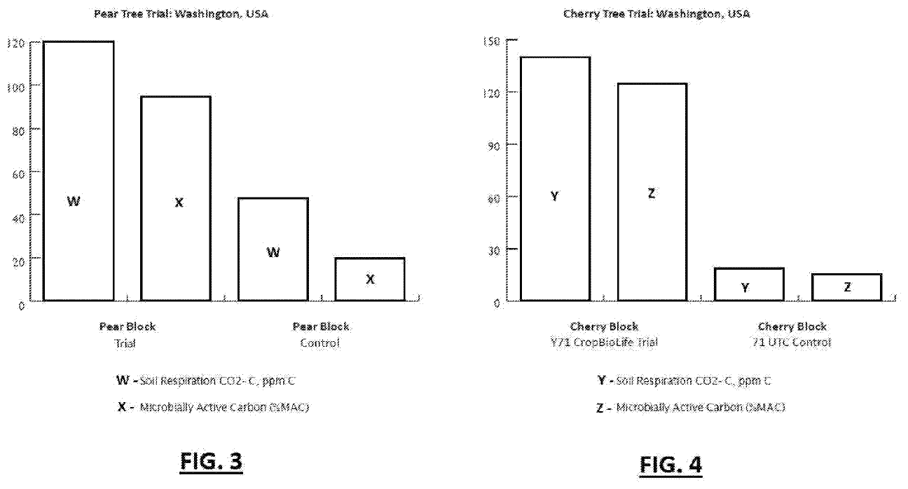

FIG. 3 and FIG. 4 depict the results of further studies undertaken by the Applicant in investigating the impact the composition of the present invention has on soil microbial health. In the trial depicted in FIG. 3, tests were conducted on pear trees based in Washington USA. In the trial sample of pear trees the composition of the present invention was applied to the trees in the manner as described above and the results were compared against a control block of pear trees that were not applied with the composition. The soil respiration CO₂ results provide an indicator of total soil biology and the results clearly show that the soil respiration of the trial trees is significantly higher than that of the control trees. Similar results were shown in the Microbial Active Carbon (MAC) measurements taken for both instances. The MAC is an indicator of how efficiently the soil microbes are using the carbon in the soil. As can be seen, the trial block of pear trees has a significantly higher MAC than the control pear tree block. FIG. 4 depicts another test conducted by the Applicant in relation to cherry trees. The differences in the test results are even more significant than those results obtained in the pear tree study of FIG. 3, the trial results clearly indicate an increase in soil respiration and MAC percentages when compared to the cherry trees not treated with the composition of the present invention. Each of the above referenced trials conducted by the applicant used a portable photosynthesis meter to obtain the results. The results clearly show an increase in CO2 exchange from the atmosphere into the plant over a variety of fruit trees, vegetable and grain crops of more than 40% when compared to untreated plants.

TABLE 2 and TABLE 3 below depict the results of the trial referred to above in relation to tomato plants as conducted by the Applicant. These results determine the Chlorophyll concentration (SPAD) and the fluorescence of photosystem II of the plants in the trial. A control plant was also used that had not been treated at all. Chlorophyll content was determined by a Chlorophyll Meter SPAD-502Plus (Europe) and fluorescence of photosystem II was determined by a mini-PAM (miniaturized pulse amplitude-modulated photosynthesis yield analyzer; Walz, GmbH, Germany). As can be seen from the results depicted in TABLE 2 and TABLE 3, there was an approximate ten percent increase in Chlorophyl fluorescence in the plants treated with the composition of the present invention, which is an indicator of photosynthetic energy conversion in plants.

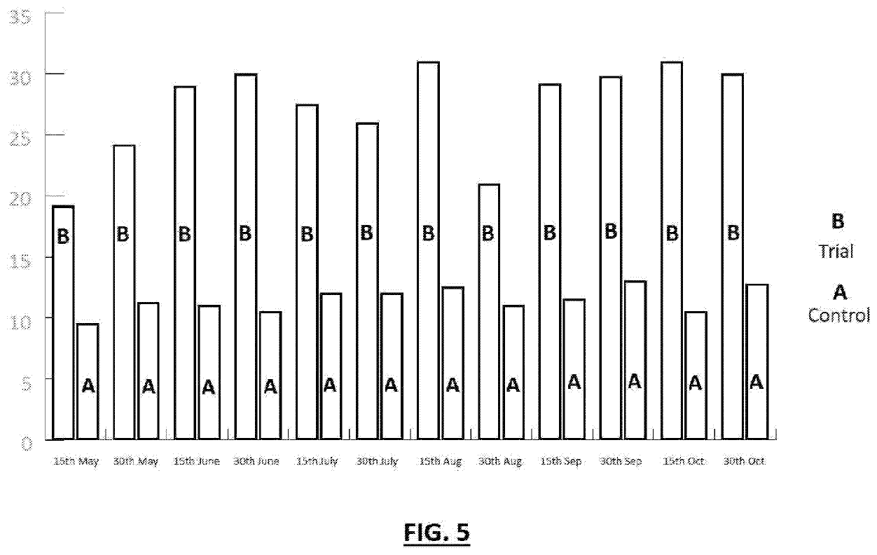

As previously discussed, there exists published experimental data on the function of plants and trees in the creation of glucose through the process of photosynthesis utilising CO₂ present in the atmosphere. FIG. 5 depicts test results associated with a trial conducted by the Applicant in relation to the application of the composition of the present invention to Malbec grape vines in the Napa Valley, USA. The results show a measure of Brix present in the leaf of the grape plants to provide a measure of glucose production. As can be clearly seen from the results over the given time period, the data demonstrates that the composition of the present invention stimulates up to a 300% increase in glucose production in the plants throughout the growing season.

It is understood through published data that it is possible for plants or trees to convert and transport up to 60% of the glucose produced to the roots of the plant. Trials conducted by the Applicant in relation to a large Safflower crop have demonstrated improved carbon levels within the roots of the crop sprayed with the composition of the present invention when compared to the untreated crop plants. Further, and as is shown in FIG. 6 in relation to the tomato plant trial, the composition of the present invention produced an average of 96% increase in root biomass when compared to the untreated plants of the control.

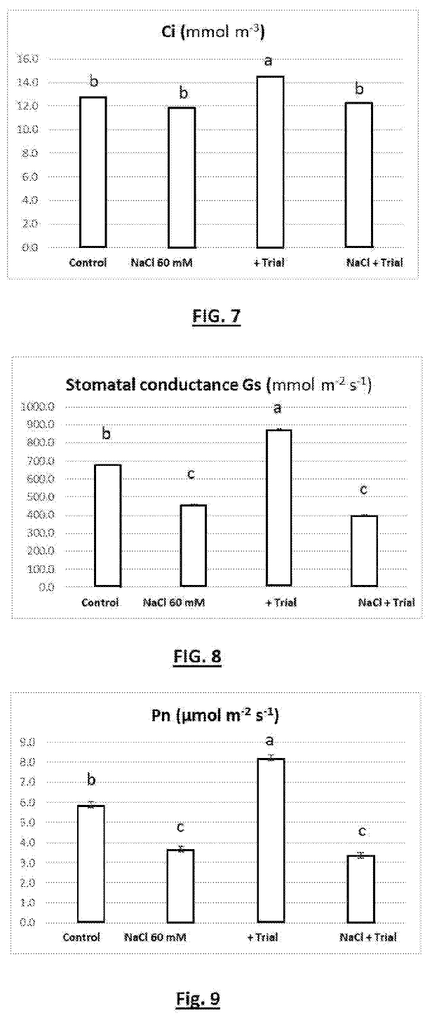

It is understood that stomata on leaves are responsible for the pathway of CO₂ into the plant. FIG. 7-FIG. 9 show the results from a trials conducted by the Applicant in relation to tomato plants, as previously discussed. The results depicted in FIG. 8 show that a tomato plant treated with the composition of the present invention provides a 29% gain in stomata conductance when compared to an untreated plant. Stomata conductance is a measure of the rate of diffusion of CO2 into the leaf and the ability of the plant to absorb CO₂ from the atmosphere. Thus, the composition of the present invention enhances the plant's ability to perform this function, a function that is fundamental to CO₂ sequestration.

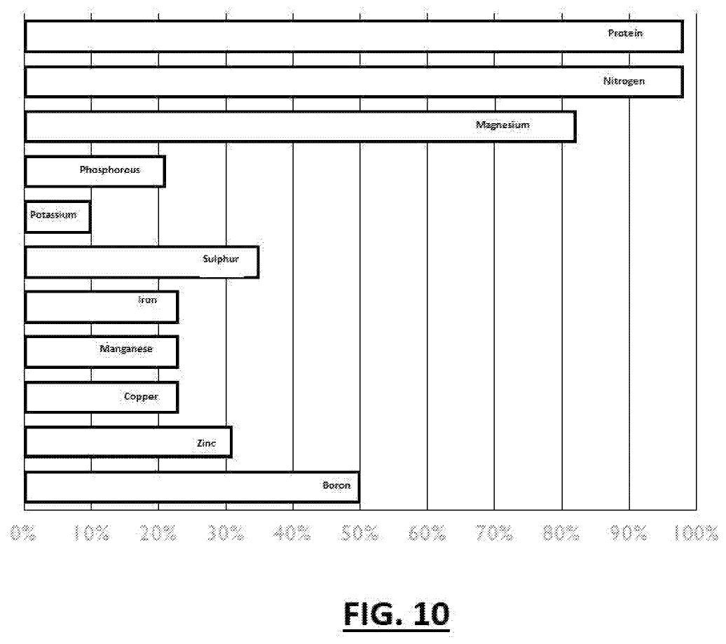

The effect of soil microorganisms on the nutrient availability and assimilation of nutrients by plants is understood. Nutrients absorbed by plants are critical for plant health and nutrient density in food. For example, Nitrogen and Magnesium are needed to form chlorophyl which is needed for the photosynthesis reaction. Boron is also needed for the transport of glucose to the roots. Trials conducted by the Applicant in relation to tomato plants show significant improvement in the nutrient value of plants treated with the composition of the present invention, this is shown in FIG. 10. The nutrient values as shown represent a percentage increase in the detected levels of nutrients in the treated plants, compared to the untreated plants. Such a proven result indicating improved assimilation of nutrients by the plants.

The applicant has found that this composition for improving plant and soil health can be used on various food crops such as vegetables, fruit and nut trees, turf, and broad acre crops such as canola, soy and wheat.

In a particularly preferred embodiment, the compositions mentioned above can include other plant foliar or irrigation additives which can provide additional benefits such as plant growth regulators and nutrients.

Through-out the specification and claims the word “comprise” and its derivatives is intended to have an inclusive rather than exclusive meaning unless the context requires otherwise.

It will be appreciated by those skilled in the art that many modifications and variations may be made to the methods of the invention described herein without departing from the spirit and scope of the invention.

The claims defining the invention are as follows:

1. A composition for increasing a plant's natural processes for absorbing CO₂ from the atmosphere comprising:
at least one bioflavonoid; and
at least one organic acid.

2. A composition according to claim 1, wherein the composition includes at least one wetting agent.

3. A composition according to claim 2, wherein the at least one wetting agent is naturally plant derived.

3. A composition according to any one of the preceding claims, wherein the composition includes at least one nutrient.

4. A composition according to any one of the preceding claims, wherein the at least one bioflavonoid is naturally plant derived.

5. A composition according to any one of the preceding claims, wherein the at least one organic acid is naturally produced.

6. A composition according to any one of the preceding claims, wherein the composition is in the form of a liquid.

7. A composition according to claim 6, wherein the composition comprises 0.25 to 20 ml in a topical composition per litre of water or other diluting agent.

8. A composition according to claim 7, wherein the topical composition is suitable for application to plant foliar including roots, leaves

9. A composition according to claim 7 or claim 8, wherein the topical composition is suitable for application as an irrigation additive.

10. A composition according to any one of the preceding claims, comprising:
between 10% to 20% (by weight) bioflavonoid; or
between 30% to 60% (by weight) organic acid; and/or
between 10% to 20% (by weight) wetting agent.

11. A composition according to any one of the preceding claims, comprising:
between 10% to 20% (by weight) bioflavonoid which is naturally plant derived; or
between 30% to 60% (by weight) organic acid which is naturally produced; and/or
between 10% to 20% (by weight) wetting agent which is naturally plant derived
between 0.5% to 5% (by weight) of micronutrients of one or more boron, magnesium and calcium

12. A composition according to any one of the preceding claims, wherein the at least one bioflavonoid is selected from the group including: citrus fruit plant extracts, including grapefruit, lemon, lime, orange, tangerine, bitter orange extract

13. A composition according to any one of the preceding claims, wherein the at least one bioflavonoid may be selected from any plant extracted flavonoid which is naturally plant derived.

14. A composition according to any one of claims 2 to 13, wherein the at least one wetting agent may be selected from a natural plant derived surfactant.

15. A composition according to any one of the preceding claims, wherein the composition includes plant foliar or irrigation treatments including at least one of plant growth regulators or plant nutrients.

16. A composition for increasing the production of Glucose in plants and trees wherein the composition comprises:
at least one bioflavonoid; and
at least one organic acid.

17. A composition according to claim 16, wherein the composition includes at least one wetting agent.

18. A composition according to claim 17, wherein the at least one wetting agent is naturally plant derived.

19. A composition according to any one of claims 16 to 18, wherein the composition includes at least one nutrient.

20. A composition according to any one of claims 16 to 19, wherein the at least one bioflavonoid is naturally plant derived.

21. A composition according to any one of claims 16 to 20, wherein the at least one organic acid is naturally produced.

22. A composition according to any one of claims 16 to 21, wherein the composition is in the form of a liquid.

23. A composition according to claim 22, wherein the composition comprises 0.25 to 20 ml in a topical composition per litre of water or other diluting agent.

24. A composition according to claim 23, wherein the topical composition is suitable for application to plant foliar including roots, leaves

25. A composition according to claim 23 or 24, wherein the topical composition is suitable for application as an irrigation additive.

26. A composition according to any one claims 16 to 25, comprising:
between 10% to 20% (by weight) bioflavonoid; or
between 30% to 60% (by weight) organic acid; and/or
between 10% to 20% (by weight) wetting agent.

27. A composition according to any one of claims 16 to 25, comprising:
between 10% to 20% (by weight) bioflavonoid which is naturally plant derived; or
between 30% to 60% (by weight) organic acid which is naturally produced; and/or
between 10% to 20% (by weight) wetting agent which is naturally plant derived between 0.5% to 5% (by weight) of micronutrients of one or more boron, magnesium and calcium

28. A composition according to any one of claims 16 to 27, wherein the at least one bioflavonoid is selected from the group including: citrus fruit plant extracts, including grapefruit, lemon, lime, orange, tangerine, bitter orange extract

29. A composition according to any one of claims 16 to 27, wherein the at least one bioflavonoid may be selected from any plant extracted flavonoid which is naturally plant derived.

30. A composition according to any one of claims 17 to 29, wherein the at least one wetting agent may be selected from a natural plant derived surfactant.

31. A composition according to any one of claims 16 to 30, wherein the composition includes plant foliar or irrigation treatments including at least one of plant growth regulators or plant nutrients.

32. A method of simultaneously increasing a plant's natural processes for absorbing CO₂ from the atmosphere and for releasing carbohydrates into the soil comprising:
forming a liquid composition comprising at least one bioflavonoid and at least one organic acid;
diluting the liquid composition by adding a diluting agent at a rate of between 0.25 ml to 20 ml liquid composition per litre of diluting agent;
spraying a first application of the diluted liquid composition to the leaves of a plant early in the growing season of the plant.

33. A method according to claim 32, wherein the method further includes spraying a second application of the diluted liquid composition to the leaves of a plant at least 3-7 days after the first application.

34. A method according to claim 32, wherein the liquid composition further includes one or more of Boron, Magnesium and Calcium at micron size particles capable of plant absorption.

35. A method according to claim 32, wherein the at least one diluting agent is water.

36. A method according to claim 32, wherein the at least one organic acid is selected from a group of mild organic acids that include: malic acid, citric acid, lactic acid, salicylic acid, caprylic acid and tartaric acid.

37. A method according to claim 35, wherein the diluting agent is added at a rate of between 0.4 ml to 4 ml liquid composition per litre of diluting agent.

38. A method according to claim 33, wherein the first application and the second application are sprayed on the leaves of the plant in a light mist or fine spray to cover the leaves.
